(19) United States
(12) Patent Application Publication
(10) Pub. No.: US 2014/0290028 A1
(43) Pub. Date: Oct. 2, 2014

(54) SPRINKLER ASSEMBLY AND METHOD

(71) Applicants: Bani Ishaya, Turlock, CA (US); Johnny Ishaya, Turlock, CA (US); Tony Ishaya, Turlock, CA (US); Yousip Ishaya, Turlock, CA (US); Zaya Davidloo, Turlock, CA (US)

(72) Inventors: Bani Ishaya, Turlock, CA (US); Johnny Ishaya, Turlock, CA (US); Tony Ishaya, Turlock, CA (US); Yousip Ishaya, Turlock, CA (US); Zaya Davidloo, Turlock, CA (US)

(21) Appl. No.: 14/245,869

(22) Filed: Apr. 4, 2014

Related U.S. Application Data
(62) Division of application No. 13/544,260, filed on Jul. 9, 2012, now abandoned.
(60) Provisional application No. 61/567,324, filed on Dec. 6, 2011.

(51) Int. Cl. B05B 15/06; B05B 15/10

(52) U.S. Cl. CPC B05B 15/065; B05B 15/10
USPC 29/428

(57) ABSTRACT

A method for engaging a sprinkler device with an irrigation network utilizing a sprinkler socket. The sprinkler socket includes a socket body having a tubular construction that defines an inner chamber. A connector tube extends through a bottom aperture into the inner chamber. During installation, a hole is dug in the ground adjacent the irrigation network so that the sprinkler socket may be inserted into the hole. The sprinkler socket is operably connected to the irrigation network. The sprinkler device is then inserted into the inner chamber of the sprinkler socket and threadedly engaged with the connector tube of the sprinkler socket.

### CROSS-REFERENCE TO RELATED APPLICATIONS

This application is a divisional application of previously filed U.S. utility patent application Ser. No. 13/544,260, filed Jul. 9, 2012, now abandoned.

This application claims the benefit of U.S. Provisional Application No. 61/567,324, filed Dec. 6, 2011.

### BACKGROUND OF THE INVENTION

1. Field of the Invention

This invention relates generally to sprinkler assemblies, and more particularly to a sprinkler socket for engaging an irrigation network and operably receiving a pop-up sprinkler device.

2. Description of Related Art

The prior art teaches various forms of sprinkler assemblies that are used to spray or otherwise direct water for watering plants.

Ferguson et al., U.S. Pat. No. 5,938,121, teaches a pop-up-sprinkler housing that has a cap sleeve that slides adjustably into a base sleeve. The base sleeve has a base plate with a fluid conveyance that screws onto underground sprinkler plumbing and into sprinkler shafts. A housing cap on top of the cap sleeve has a sprinkler-shaft aperture that is sized and shaped to allow ingress and egress of pop-up portions of select sprinkler shafts and has cap-sleeve shoulders that extend over the base sleeve and a support surface. Threaded fasteners are provided for attaching the fluid conveyance to the sprinkler shafts and to the underground sprinkler plumbing. A plurality of sprinkler adapters are provided for adaptation to different sizes and types of pop-up sprinklers.

Tyler, U.S. Pat. No. 4,840,312, teaches a sprinkler including a riser assembly and a removable nozzle module operatively connected thereto. The nozzle module includes a nozzle holder and a nozzle. The nozzle holder is accessible even when sprinkler is buried and the riser assembly is completely retracted. In a preferred embodiment, a bayonet fit exists between nozzle module and riser assembly so that it is only necessary to twist nozzle module a few degrees to disconnect it from riser assembly. Once the nozzle module is removed, the nozzle can be replaced or unplugged as necessary. The above-described references are hereby incorporated by reference in full.

The prior art teaches a sprinkler housing that is of two-piece construction. However, the prior art does not teach a sprinkler socket that is of a single piece construction, and which includes a water flow system such as is disclosed in the present invention. The present invention fulfills these needs and provides further related advantages as described in the following summary.

### SUMMARY OF THE INVENTION

The present invention teaches certain benefits in construction and use which give rise to the objectives described below.

The present invention includes a method for engaging a sprinkler device with an irrigation network installed in a ground. The method utilizes a sprinkler socket comprising a socket body having a tubular construction that defines an inner chamber, the socket body having a top end and a bottom end, a socket base closing the bottom end of the socket body, a perimeter of the top end that defines an opening shaped to receive the sprinkler device into the inner chamber. A connector tube extends through a bottom aperture into the inner chamber. A hole is dug in the ground adjacent the irrigation network so that the sprinkler socket may be inserted into the hole. The sprinkler socket is operably connected to the irrigation network. The sprinkler device is then inserted into the inner chamber of the sprinkler socket and threadedly engaged with the connector tube of the sprinkler socket.

A primary objective of the present invention is to provide a sprinkler assembly and method of installation having advantages not taught by the prior art.

Another objective is to provide a method of installing a sprinkler socket into an irrigation system so that sprinkler devices may be quickly and easily installed in the socket, and easily removed and replaced if broken.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is an exploded perspective view of a sprinkler assembly according to one embodiment of the present invention;

FIG. 2 is a partially exploded perspective view thereof, illustrating a pop-up sprinkler device positioned for insertion into a sprinkler socket, and also illustrating a pop-up riser of a pop-up sprinkler device moving from a lowered position to a raised position;

FIG. 3 is a front elevational sectional view of the pop-up sprinkler device and the sprinkler socket once they have been assembled and operably connected with an irrigation network via a connector;

FIG. 4 is a perspective view of a second embodiment of the sprinkler assembly;

FIG. 5 is a sectional view similar to FIG. 3, illustrating the second embodiment of the sprinkler assembly having a second embodiment of the connector;

FIG. 6 is an exploded perspective view of a third embodiment of the sprinkler assembly, wherein the sprinkler socket includes two connection ports;

FIG. 7 is an exploded perspective view of a fourth embodiment of the sprinkler assembly;

FIG. 8 is an exploded perspective view of a fifth embodiment of the sprinkler assembly;

FIG. 9 is a sectional view of the sprinkler socket of FIG. 8;

FIG. 10 is an exploded perspective view of the sprinkler unit of FIG. 1, illustrating an optional rubber washer that may surround a top end of the sprinkler body;

FIG. 11 is an exploded perspective of the rubber washer on the sprinkler unit, the sprinkler unit being positioned for insertion into the sprinkler socket; and

FIG. 12 is a perspective view of another embodiment of the sprinkler unit, wherein the sprinkler unit does not include a flange.

### DETAILED DESCRIPTION OF THE INVENTION

The above-described drawing figures illustrate the invention, a sprinkler assembly 10 that is adapted to be installed in an irrigation network 12 for watering plants.

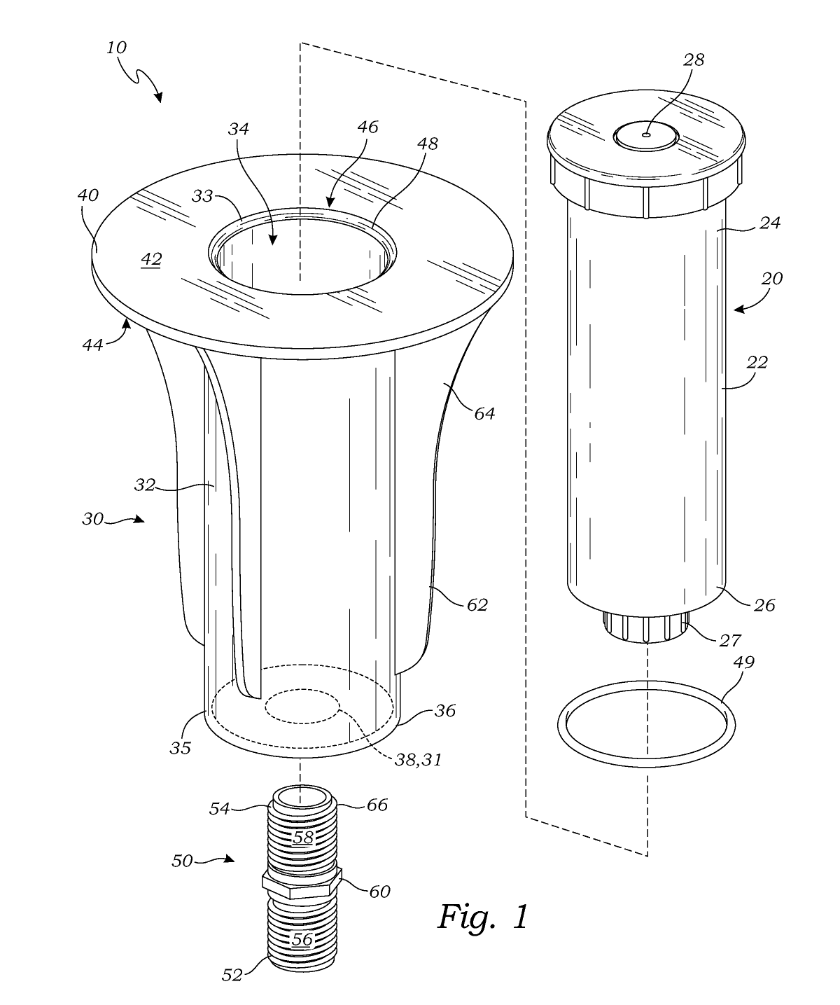

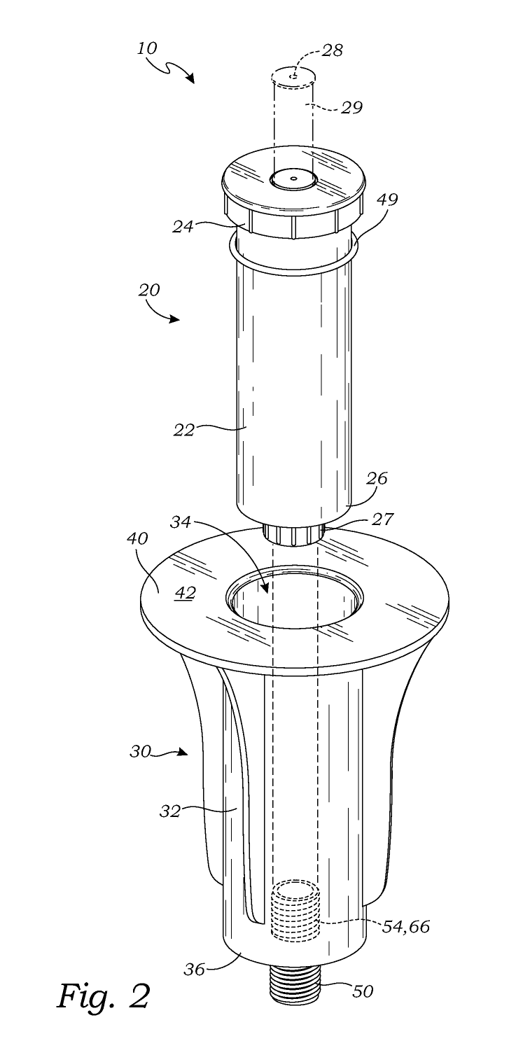

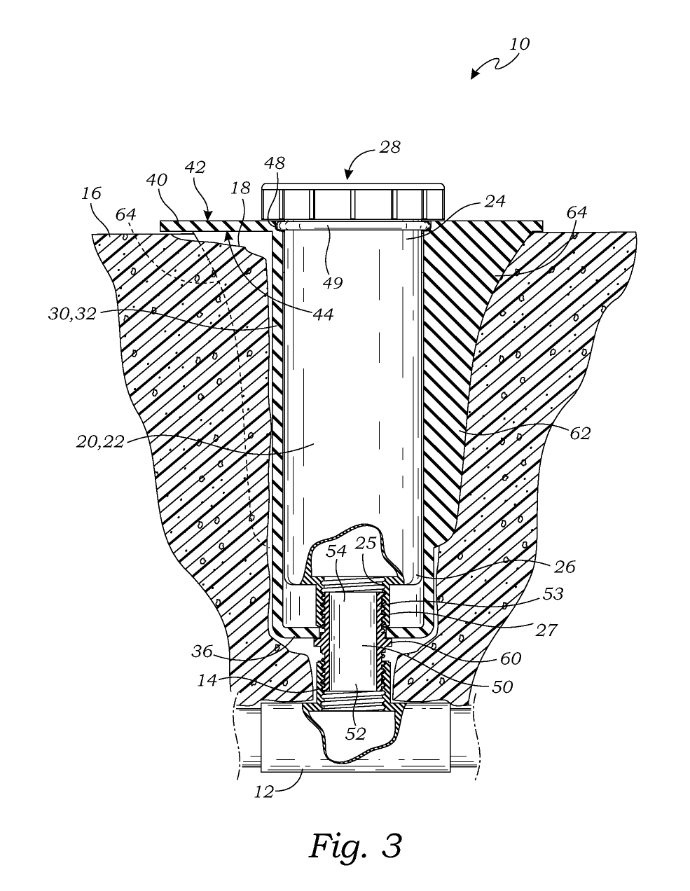

FIG. 1 is an exploded perspective view of the sprinkler assembly 10 according to a first embodiment of the present invention. FIG. 2 is a partially exploded perspective view thereof, illustrating a sprinkler device 20 positioned for insertion into a sprinkler socket 30, and also illustrating a pop-up riser 29 of the sprinkler device 20 moving from a lowered position to a raised position. FIG. 3 is a front elevational sectional view of the sprinkler device 20 and the sprinkler socket 30 once they have been assembled and operably connected with an irrigation network via a connector tube 50.

As illustrated in FIGS. 1-3, the sprinkler device 20, and may include a sprinkler body 22 having a top end 24 and a bottom end 26. The sprinkler body 20 may be a single piece tubular construction. While the sprinkler body 20 is illustrated with a round cross-section, other cross-sectional shapes may also be utilized. A nozzle 28 in the top end 24 may be adapted to spray water for irrigation. The bottom end 26 may include a port 27 that is threaded or otherwise adapted to engage the sprinkler socket 30, as discussed below, for receiving water from the irrigation network 12. In one embodiment, the sprinkler device 20 may be a pop-up sprinkler device, wherein the nozzle 28 is positioned on the pop-up riser 29, as illustrated in FIG. 2. While one embodiment of the pop-up sprinkler device 20 is illustrated, it may include any prior art sprinkler device already used in the market, and such alternatives may also be utilized as part of the sprinkler assembly 10.

In the embodiment of FIGS. 1-3, the sprinkler socket 30 includes a socket body 32, with a top end 33 and a bottom end 35, that defines an inner chamber 34 shaped to receive the pop-up sprinkler device 20. The inner chamber 34 may further include an inner surface 37 and an outer surface 39. In the present embodiment, the inner chamber 34 is generally cylindrical in shape, to receive the generally cylindrical pop-up sprinkler device 20; however, alternative shapes may also be utilized if desired.

A socket base 36 closes the bottom end 35 of the socket body 32, and may include a bottom aperture 38, having an aperture perimeter 31, which is used in connecting the sprinkler unit 20 with the irrigation network 12, as described in greater detail below. The top end 33 of the sprinkler socket 30 may include a top flange 40 that includes a top surface 42 and an opposed bottom surface 44. A perimeter 48 of the top end 33 defines an opening 46 that allows access to the inner chamber 34. In one embodiment, the perimeter 48 may be beveled to receive an O-ring 49 between the sprinkler socket 30 and the pop-up sprinkler device 20 when the pop-up sprinkler device 20 is operably installed in the sprinkler socket 30.

The sprinkler socket 30 may further include at least one outwardly extending protrusion 62, in this case three protrusions 62, to prevent the rotational movement of the sprinkler socket 30 when it is operably positioned in the ground. In one embodiment, the protrusions 62 include a plurality of longitudinal ribs that extend radially outward from an outer surface 39 of the sprinkler socket 30. In this embodiment, there are three longitudinal ribs, but two, three, four, or even more may be used.

In the present embodiment, the longitudinal ribs 62 each include a web portion 64 that extends upwardly to join with the top flange 40. This not only further prevents rotation of the sprinkler socket 30 in the ground, but it also serves to strengthen the top flange 40 so that it is not as easily broken or bent.

As illustrated in FIG. 3, the sprinkler socket 30 is adapted to be attached to the irrigation network 12 and receive the sprinkler device 20. The sprinkler socket 16 may be connected to the irrigation network 12 via a hole 18 dug into the ground 16 over the port 14 of the irrigation network 12. The sprinkler socket 30 is attached to the irrigation network 12 with the connector tube 50. A fluid flow system 60 directs water from the connector tube 50 into the sprinkler device 10 when the sprinkler device 10 is operably installed in the sprinkler socket 20. Dirt is then filled into the hole 18 around the sprinkler socket 30 to engage the longitudinal ribs 62 so that the sprinkler socket 16 can't rotate with respect to the ground 16.

In the present embodiment, the connector tube 50 may be a connector tube that includes an outer end 52 and an inner end 54. In this embodiment, the outer end 52 is adapted to engage the irrigation network 12 and the inner end 54 is adapted to engage the sprinkler device 20. The connector tube 50 of this embodiment may be installed through the bottom aperture 38 of the socket base 36. A connector flange 56 may abut the socket base 36 to correctly position the connector tube 50 and to ensure a strong installation.

In this embodiment, the port 14 of the irrigation network 12 has an internally threaded surface 25, and the outer end 52 of the connector tube 50 has an externally threaded surface 53 that enables the sprinkler socket 30 to be threadedly connected with the irrigation network 12. Similarly, the port 27 of the sprinkler unit 20 has an internally threaded surface 25 which may then threadedly engage the inner end 54 of the connector tube 50. In this manner, if the pop-up sprinkler device 20 is damaged, it may easily be removed (via simply unscrewing it) and replaced without requiring any digging or tampering with the irrigation network 12.

Alternative methods of connecting these components connectors may be used, as long as they may be operably installed with the irrigation network 12 and operably engage the pop-up sprinkler device 20.

The sprinkler assembly 10 may further include a fluid flow system 66 that directs water from the connector tube 50 into the sprinkler body 22 when the sprinkler body 22 is operably installed in the sprinkler socket 30. In this embodiment, the fluid flow system 66 is provided by the inner end 54 of the connector tube 50. While one embodiment of the fluid flow system 66 is illustrated in FIGS. 1-3, alternative arrangements may be utilized as deemed appropriate by one skilled in the field, and several alternative embodiments are discussed in greater detail below.

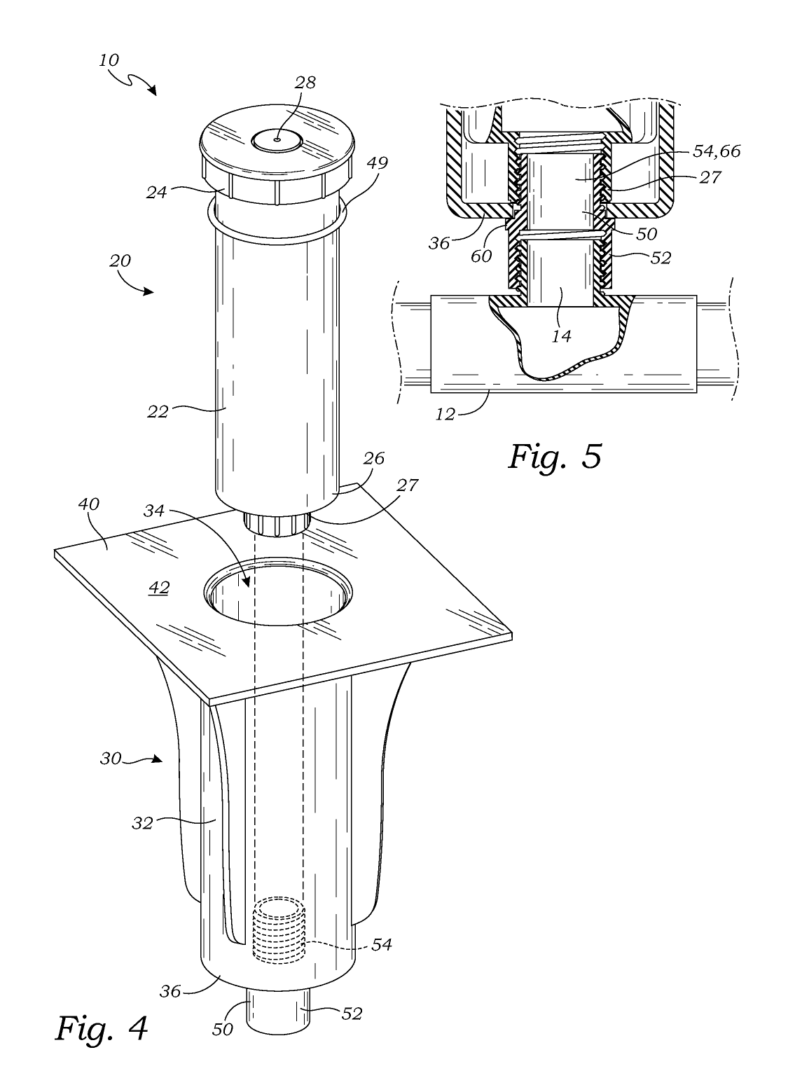

FIG. 4 is a perspective view of a second embodiment of the sprinkler assembly 10. FIG. 5 is a sectional view thereof. As illustrated in FIGS. 4-5, various features of the sprinkler socket 30 may be differently shaped, have different cross sectional shapes, etc., or may be removed entirely. For example, the top flange 40 of this second embodiment is square rather than round. As illustrated in this embodiment, the outer end 52 of the connector tube 50 may include an internally threaded (female) connector rather than a male connector, for connecting to the irrigation network 12. All of the connections described herein may be reversed, or replaced with equivalent connection structures, depending upon the needs of the user.

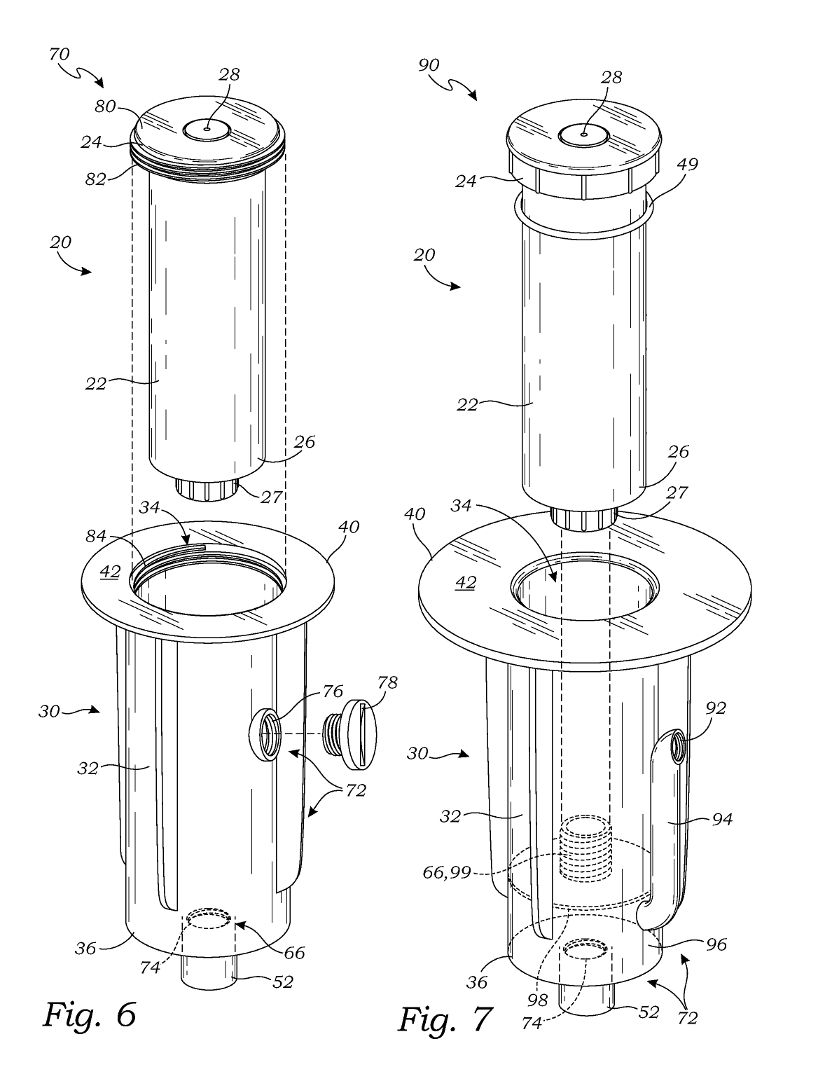

FIG. 6 is an exploded perspective view of a third embodiment of the sprinkler assembly 70. In this embodiment, the sprinkler socket 30 includes multiple connection ports 72, in this case a bottom port 74 and a side port 76, that enable the sprinkler socket 30 to be attached to the irrigation system (not shown in this figure) in the multiple locations. This is beneficial because the sprinkler socket 30 is able to be installed in a traditional irrigation system, wherein the pipes are buried a significant depth beneath the surface, or in an irrigation system that is only buried a small distance beneath the surface, thus saving expense in installation. The sprinkler socket 30 of this embodiment includes a plug 78 that can be used to close the ports 72 that are not being used.

As illustrated in FIG. 6, in this embodiment the sprinkler unit 20 includes a flange 80 that includes a threaded perimeter 82 which threadedly engages an internally threaded perimeter 84 of the sprinkler socket 30. In this embodiment, the port 27 of the sprinkler unit 20 does not engage the sprinkler socket 30; instead, the sprinkler device 20 engages the sprinkler socket 30 via the threaded perimeter 82 of the flange 80.

In operation, the fluid flow system 66 of the third embodiment of the sprinkler assembly 70 of FIG. 6 directs water from the irrigation network 12 to the inner chamber 34 of the sprinkler socket 30 via one of the connection ports 72. As the inner chamber 34 fills with water, the pressure may increase such that the water is forced into the pop-up sprinkler device 20, to be emitted by the nozzle 28. When the side port 76 is used, and the bottom port 74 is closed with the plug 78, the irrigation network 12 may not have to be buried as deeply and thus minimizes time and energy involved in the installation and repair of the sprinkler assembly 10.

FIG. 7 is an exploded perspective view of a fourth embodiment of the sprinkler assembly 90. As illustrated in the embodiment of FIG. 7, an alternative side port 92 is formed at the terminus of an s-shaped pipe 94 through which water may travel from the irrigation network 12 into the sprinkler socket 30. In this embodiment, the s-shaped pipe 94 directs water into a divided inner chamber 96 of the sprinkler socket 30, beneath a floor 98 that separates the top end 33 of the sprinkler socket 30 from the base 36 of the sprinkler socket 30. Water from the irrigation network 12 may then travel through the s-shaped pipe 72 into the divided inner chamber 34 before being forced through an inner connector 99, upwards through the sprinkler body 22, and out through the nozzle 28. As a result of this construction illustrated in FIG. 7, the entire inner chamber 34 does not have to fill with water in order to be emitted through the nozzle 28.

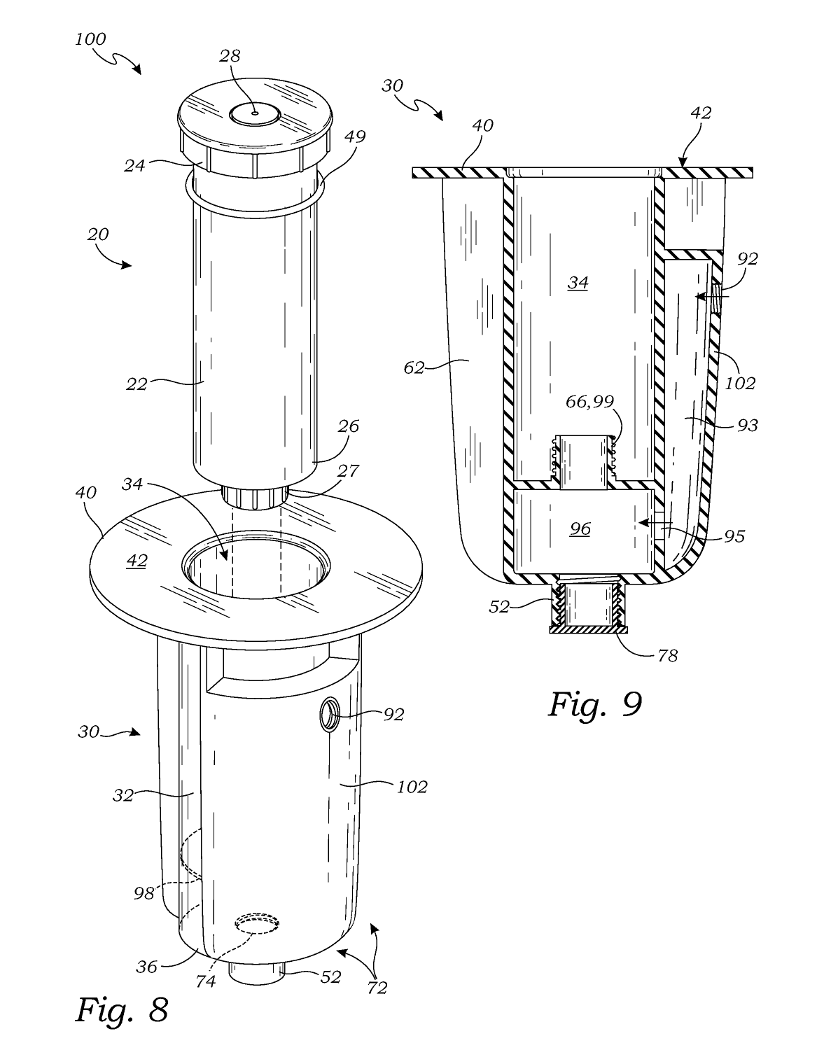

FIG. 8 is an exploded perspective view of fifth embodiment of the sprinkler assembly 100. FIG. 9 is a sectional view of the sprinkler socket 30 of FIG. 8, illustrating a cover 102. As illustrated in FIGS. 8-9, the cover 102 includes the side port 92 and forms a side chamber 93 that communicates with the inner chamber 96 via an opening 95. When the side port 92 is being used, the plug 78 may be used to close the outer end 52, as illustrated.

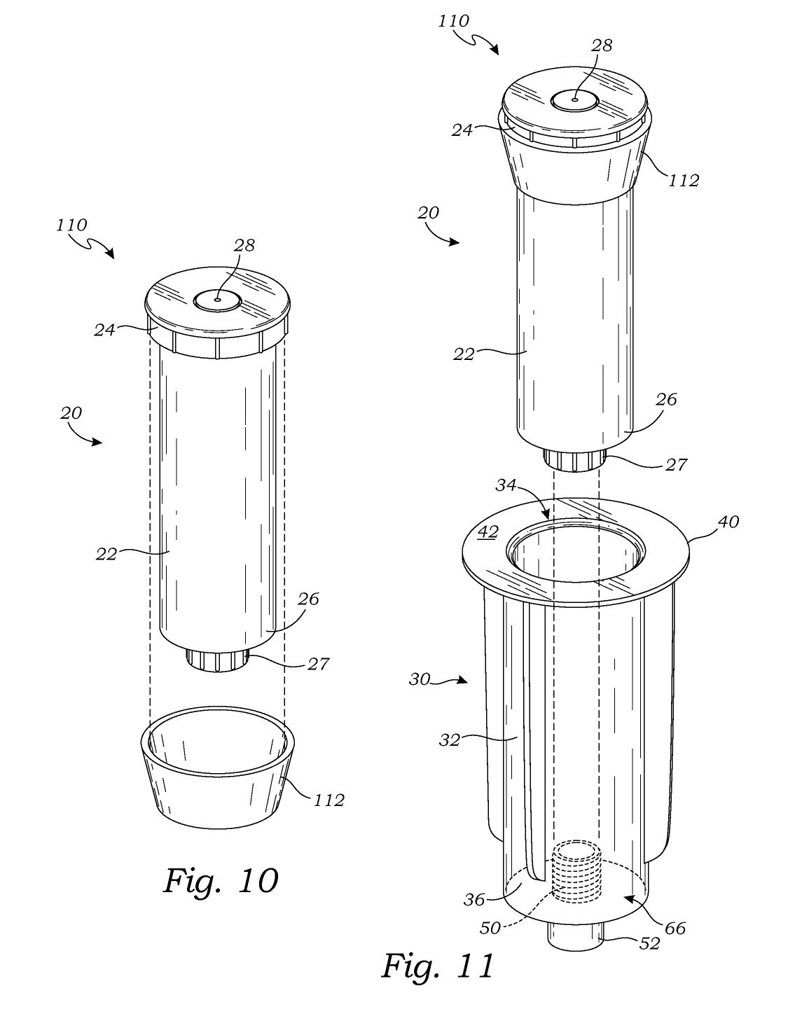

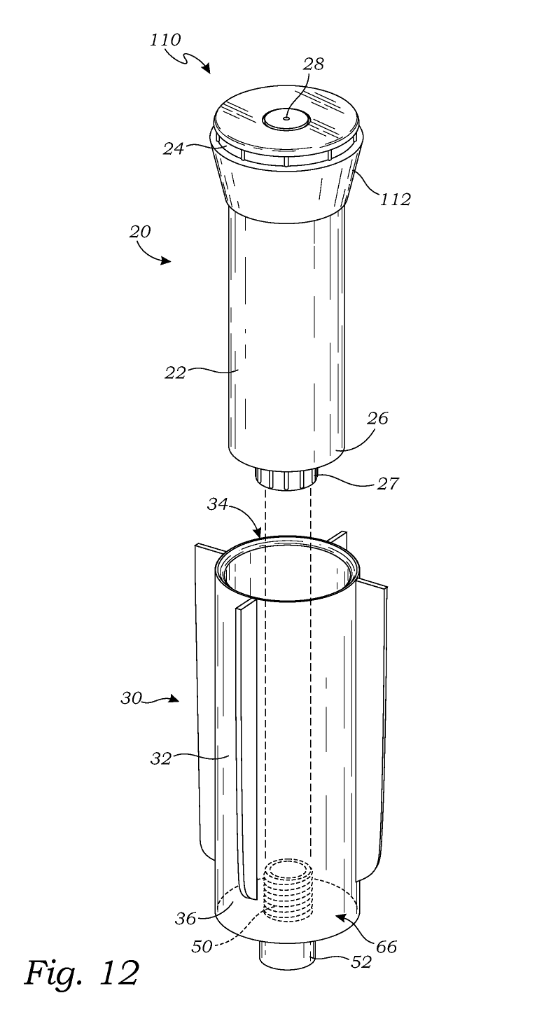

FIG. 10 is an exploded perspective view of the sprinkler unit 20 in a sixth embodiment of the sprinkler assembly 110, illustrating an optional rubber washer 112 that may surround the top end 24 of the sprinkler body 22. FIG. 11 is an exploded perspective of the rubber washer 112 operably mounted on the sprinkler unit 20, the sprinkler unit 20 being positioned for insertion into the sprinkler socket 30. As FIGS. 10-11 illustrate, the rubber washer 112 may be used to replace the O-ring previously described herein. In this embodiment, the rubber washer 112 is generally conical, although a variety of shapes may be used. The term “rubber” in this instance is hereby defined to include rubber and similar resilient and/or rubber-like materials.

FIG. 12 is a perspective view of another embodiment of the sprinkler unit 110, wherein the sprinkler unit 110 does not include a flange (element 40 in FIG. 1). As illustrated in FIG. 12, this flange is optional, and is not required in all embodiments.

The present application also includes a method of engaging the sprinkler device 20 having the internally threaded surface 25 with the irrigation network 12 installed in the hole 18 in the ground 16. First, providing the sprinkler socket 30 comprising the socket body 32 having a tubular construction that defines the inner chamber 34, the socket body 32 having the top end 33 and the bottom end 35, the socket base 36 closing the bottom end 35 of the socket body 32, the perimeter 48 of the top end 41 that defines the opening 46 shaped to receive the sprinkler device 20 into the inner chamber 34, the bottom aperture 38 through the socket base 36, the connector tube 50 extending upwardly from the aperture perimeter 31 of the bottom aperture 38 into the inner chamber 34, the connector tube 50 having an externally threaded outer surface 53. Then, digging the hole 16 in the ground adjacent 18 the irrigation network 12 and inserting the sprinkler socket 30 into the hole 16. Next, operably connecting the sprinkler socket 30 to the irrigation network 12. To connect the sprinkler device 20, inserting the sprinkler device 20 into the inner chamber 34 of the sprinkler socket 30. Finally, threadedly engaging the internally threaded surface 25 of the sprinkler device 20 with the externally threaded outer surface 53 of the connector tube 50 so that the sprinkler device 20 can receive water from the irrigation network 12.

As used in this application, the words “a,” “an,” and “one” are defined to include one or more of the referenced item unless specifically stated otherwise. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application.

What is claimed is:

1. A method for engaging a sprinkler device having a port with an internally threaded surface with an irrigation network installed in a ground, the method comprising the steps of:
providing a sprinkler socket comprising:
a socket body having a tubular construction that defines an inner chamber, the socket body having a top end and a bottom end, a socket base closing the bottom end of the socket body, a perimeter of the top end that defines an opening shaped to receive the sprinkler device into the inner chamber; and
a connector tube extending through a bottom aperture of the socket base such that an upper end of the connector tube extends upwardly into the inner chamber, the upper end of the connector tube having an externally threaded outer surface;
digging a hole in the ground adjacent the irrigation network;
inserting the sprinkler socket into the hole;
operably connecting the connector tube of the sprinkler socket to the irrigation network;
inserting the sprinkler device into the inner chamber of the sprinkler socket; and
threadedly engaging the port of the sprinkler device with the connector tube so that the sprinkler device is operably connected with the irrigation network.

2. The method of claim 1, further comprising the steps of:
removing the sprinkler device from the socket in the event that it is damaged; and
replacing the sprinkler device with a new sprinkler device, without requiring any digging in the ground, or direct interaction with the irrigation network.

3. The method of claim 1, wherein the connector tube further includes a lower end extending downwardly from the sprinkler socket, and further comprising the step of threadedly engaging the lower end of the connector tube with the irrigation network.

4. A method for installing a sprinkler system in a ground having an irrigation network, the method comprising the steps of:
providing a sprinkler device having a sprinkler body having a top end and a bottom end, the sprinkler body having a single piece tubular construction, the top end having a pop-up riser that includes a nozzle for spraying water, the bottom end having a port with an internally threaded surface for receiving water from the irrigation network and directing it through the sprinkler device and out through the nozzle of the pop-up riser;
providing a sprinkler socket comprising:
a socket body having a tubular construction that defines an inner chamber, the socket body having a top end and a bottom end, a socket base closing the bottom end of the socket body, a perimeter of the top end that defines an opening shaped to receive the sprinkler device into the inner chamber;
a top flange extending outwardly from the top end of the socket body;
a plurality of longitudinal ribs that extend radially outward from an outer surface of the sprinkler socket; and
a connector tube extending through a bottom aperture of the socket base such that an upper end of the connector tube extends upwardly into the inner chamber, the upper end of the connector tube having an externally threaded outer surface;
digging a hole in the ground adjacent the irrigation network;
inserting the sprinkler socket into the hole;
operably connecting the connector tube of the sprinkler socket to the irrigation network;
filling the hole so that the longitudinal ribs are engaged with the ground such that the sprinkler socket cannot rotate with respect to the ground;
inserting the sprinkler device into the inner chamber of the sprinkler socket; and
threadedly engaging the port of the sprinkler device with the connector tube so that the sprinkler device is operably connected with the irrigation network.
